(19) United States
(12) Patent Application Publication
(10) Pub. No.: US 2018/0074335 A1
(43) Pub. Date: Mar. 15, 2018

(54) Display Apparatus and Method

(71) Applicant: Eduard Almashe, Hod Hasharon (IL)

(72) Inventor: Eduard Almashe, Hod Hasharon (IL)

(21) Appl. No.: 15/265,864

(22) Filed: Sep. 15, 2016

(51) Int. Cl. G02B 27/22

(52) U.S. Cl. CPC G02B 27/2278; G02B 27/2292

(57) ABSTRACT

An apparatus for displaying tri-dimensional objects, comprising a pair of parallel boards, with each board having holes therein. The boards are planar. The holes are arranged in a pattern, and the patterns of holes in the two boards are identical. The pattern comprises holes arranged in a plurality of parallel rows. The holes are circular, rectangular or oval.

### CROSS-REFERENCE TO RELATED APPLICATIONS

None

### STATEMENT REGARDING FEDERALLY SPONSORED RESEARCH OR DEVELOPMENT

None

### THE NAMES OF THE PARTIES TO A JOINT RESEARCH AGREEMENT

None

### BACKGROUND OF THE INVENTION

### Field of the Invention

The present invention relates to an apparatus for displaying tri-dimensional objects.

### Description of Related Art Including Information

A tri-dimensional display is useful to attract passersby's attention or to improve the appearance of fences or buildings, or as decorative means at home or at work, etc.

At present, tri-dimensional displays require expensive means such as holograms, or may require the people to wear special glasses.

Other devices cannot be used outdoors, in direct sunlight.

The present invention addresses these and other problems in this art.

### BRIEF SUMMARY OF THE INVENTION

The present invention aims to provide a low-cost tri-dimensional display which can be used to decorate rooms, buildings, fences, etc.

The new display can be used indoors or outdoors.

The display can be used in daylight or at night.

People need not wear special glasses in order to view the display.

According to one aspect of the invention, the new display uses two parallel boards, each having an identical pattern of holes.

It was found by the present inventor that, as people look at the boards, a tri-dimensional display is presented to them. The display may include a plurality of spheres floating in space.

According to another aspect of the invention, a rectangular body comprising six boards having holes therein, will present a tri-dimensional display when viewed from various directions.

According to yet another aspect of the invention, two parallel boards with holes in an identical pattern can be used as a fence, or an addition to a fence, to improve its appearance by displaying tri-dimensional shapes.

### BRIEF DESCRIPTION OF THE SEVERAL VIEWS OF THE DRAWINGS

In the figures, which illustrate, by way of example, preferred embodiments of the present invention:

FIG. 1 illustrates a tri-dimensional display device.

FIG. 2 illustrates a pair of parallel boards for creating a tri-dimensional display.

FIG. 3 illustrates a top view of the pair of parallel boards for creating a tri-dimensional display.

FIG. 4 illustrates a fence comprising a pair of parallel boards.

FIGS. 5A to 5F illustrate various shapes of holes usable for the perforated boards. FIG. 5F illustrates an arbitrarily-shaped body comprising two parts 18 and 19. The parts may have a different width each, to achieve a different visual effect. More complex structures are also possible.

FIG. 6 illustrates a tri-dimensional display device with built-in illumination means.

FIG. 7 illustrates another embodiment of a tri-dimensional display device with built-in

FIGS. 8A to 8D illustrate various shapes of bodies presenting a tri-dimensional display.

FIG. 9 illustrates a tri-dimensional display mounted on a building's balcony.

FIG. 10 illustrates a tri-dimensional display test frame.

### DETAILED DESCRIPTION OF THE INVENTION

The following detailed description is made with reference to the figures.

The invention will now be described by way of example and with reference to the accompanying drawings.

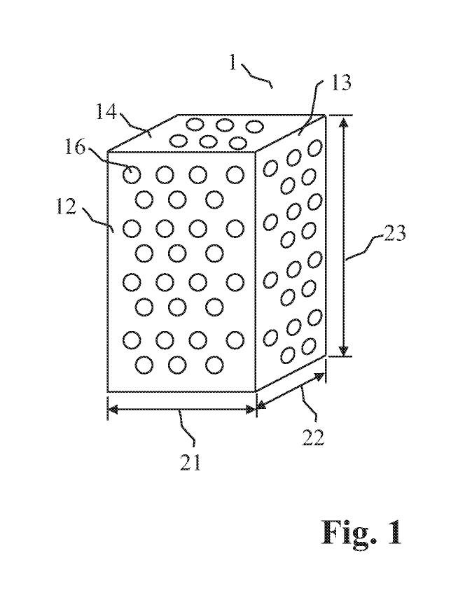

Referring to FIG. 1, a tri-dimensional display device 1 is illustrated. When the device 1 is viewed from various directions, it appears there are tri-dimensional spheres floating in the device.

The tri-dimensional display device 1 comprises a rectangular structure, with four lateral boards such as boards 12, 13, a top board 14 and a bottom board (not shown).

All the boards have circular holes 16 therein. The pattern of holes in two parallel boards creates the tri-dimensional image.

In a preferred embodiment, the boards are planar, that is they comprise a plane surface.

In one embodiment of the invention as shown in FIG. 1, the device 1 has a width 21 of about 19 centimeters (cm), a depth 22 of about 19 cm and a height 23 of about 25 cm.

Other dimensions are possible, to create tri-dimensional displays of other dimensions.

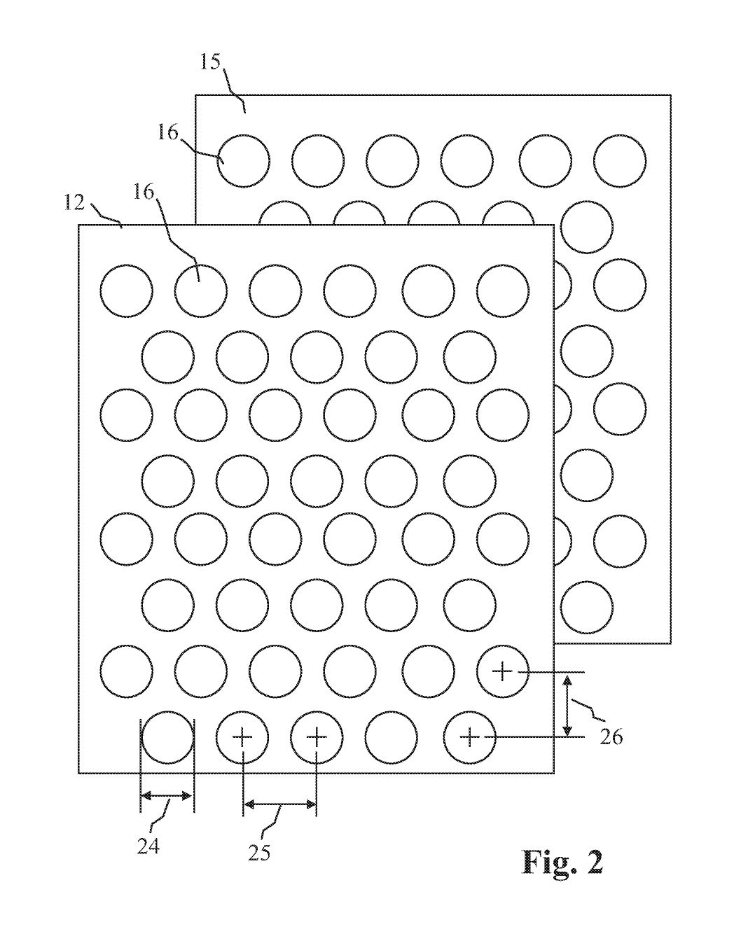

FIG. 2 illustrates a pair of parallel boards 12 and 15, such as those comprising the device 1 in FIG. 1, for creating a tri-dimensional display.

The two parallel boards 12, 15 have an identical pattern of the holes 16.

In one embodiment of the device, the holes diameter 24 is about 12 millimeters (mm). The horizontal distance 25 between holes (measured between the holes centers as shown) is about 18 mm.

The vertical distance 26 between holes (measured between the holes centers) is about 14 mm.

The device may be scaled up or down to present a larger or smaller tri-dimensional display.

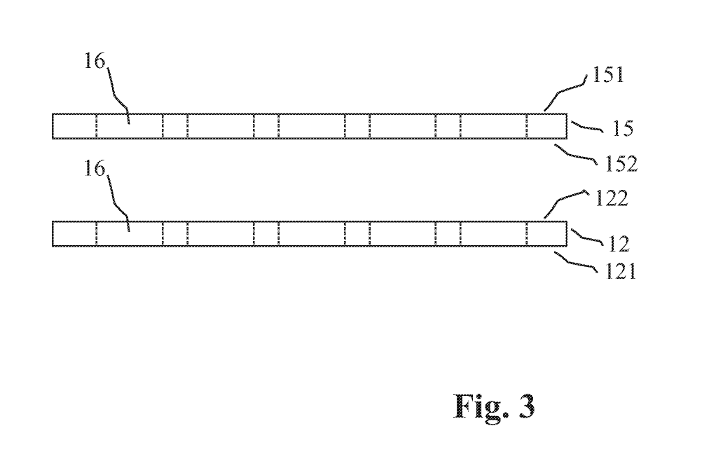

FIG. 3 illustrates a top view of the pair of parallel boards 12, 15 for creating a tri-dimensional display.

In a preferred embodiment, the outer surfaces 121, 151 if the two parallel boards 12, 15 is matte, whereas the inner surfaces 122, 152 is mirror-like.

The boards 12 and 15 may be made of plastic boards about 2.5 mm thick.

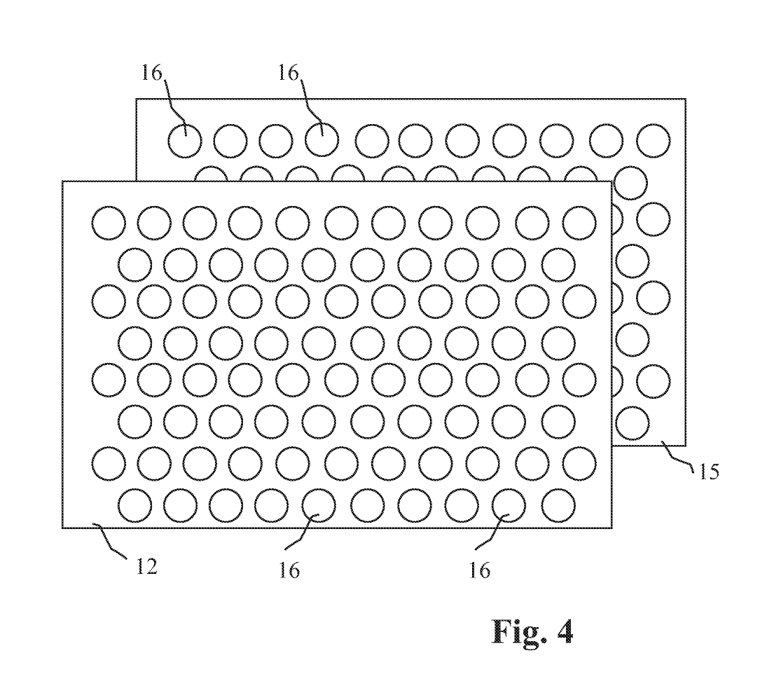

FIG. 4 illustrates a fence comprising a pair of parallel boards 12 and 15. The two parallel boards 12, 15 have an identical pattern of holes 16.

Units of parallel boards as illustrated may form segments of the fence; several such units may be used for a long fence, in a modular structure.

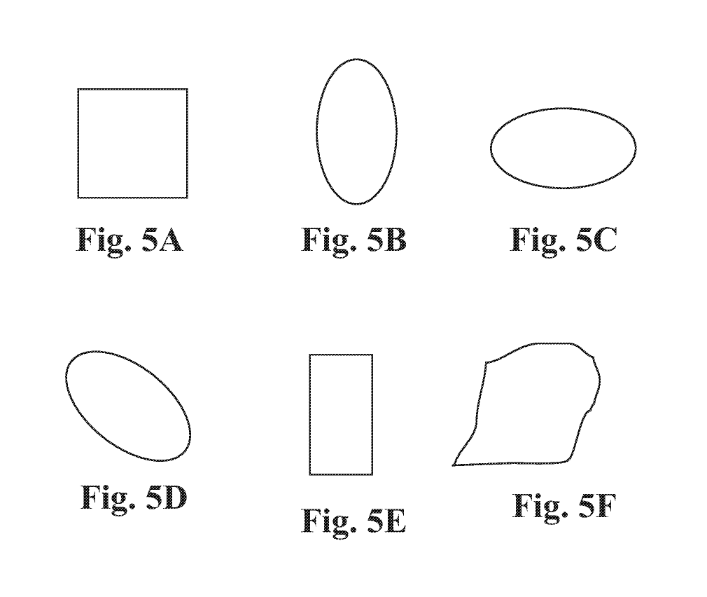

FIGS. 5A to 5F illustrate various shapes of holes usable for the perforated boards. It was found that the holes need not be circular, rather various shapes may be used. The holes may be circular, rectangular, oval, etc.

FIG. 5F illustrates an arbitrarily-shaped hole.

Preferably, the two parallel boards have an identical pattern of holes, and the shape of the holes is the same for both boards.

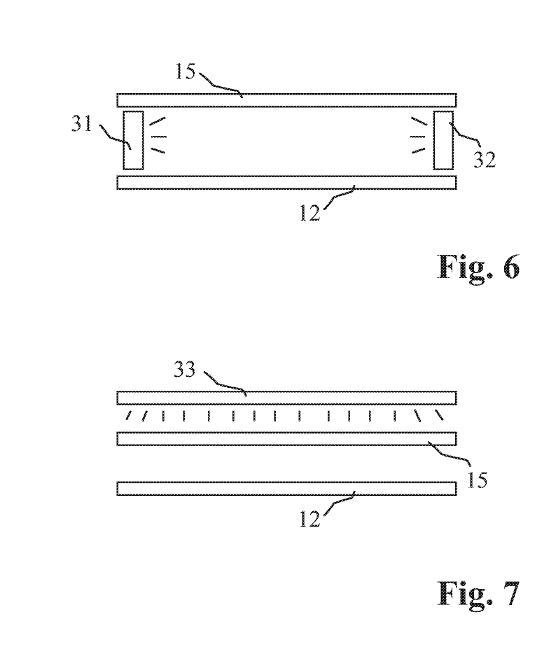

FIG. 6 illustrates a tri-dimensional display device with built-in illumination means. The device includes two parallel boards 12, 15 with holes as described above, and illumination means 31, 32. The illumination means 31, 32 may be located on both sides of the display, or on all four sides of the display.

The illumination allows the device to be used at night. Colored lights may be used for an enhanced effect.

In another preferred embodiment, lights having changing colors may be used.

FIG. 7 illustrates another embodiment of a tri-dimensional display device with built-in illumination means. The device includes two parallel boards 12, 15 with backlit illumination means 33.

The illumination allows the device to be used at night. Colored lights may be used for an enhanced effect.

In another preferred embodiment, lights having changing colors may be used.

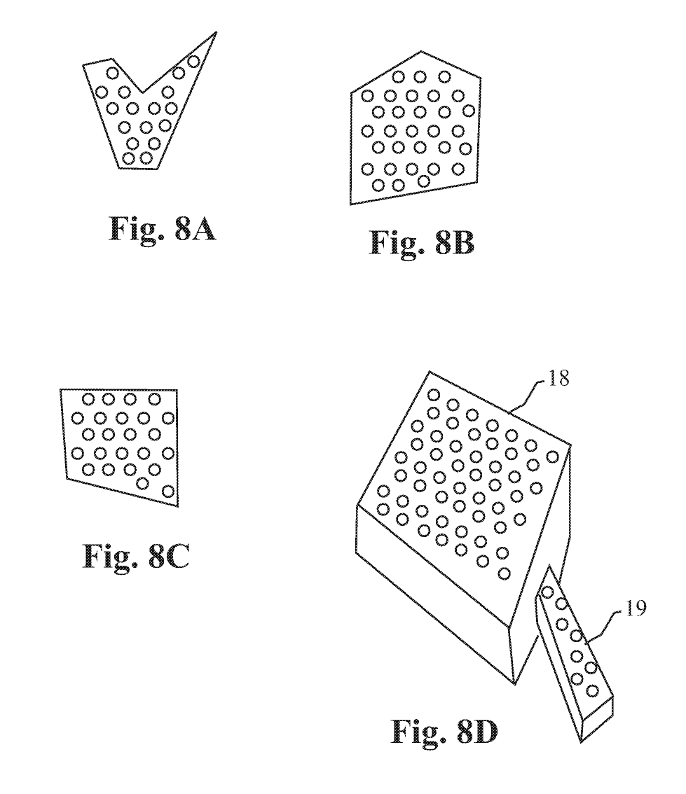

FIGS. 8A to 8D illustrate various shapes of bodies presenting a tri-dimensional display.

FIGS. 8A, 8B and 8C include a pair of parallel boards with holes therein, wherein each board has the shape as illustrated.

The device in FIG. 8D has a more complex shape, including a body comprising two parts 18 and 19.

The parts 18 and 19 may each have a different width, to achieve a different visual effect. A person skilled in the art may appreciate that more complex structures are also possible, using the method and approach as illustrated with FIG. 8D.

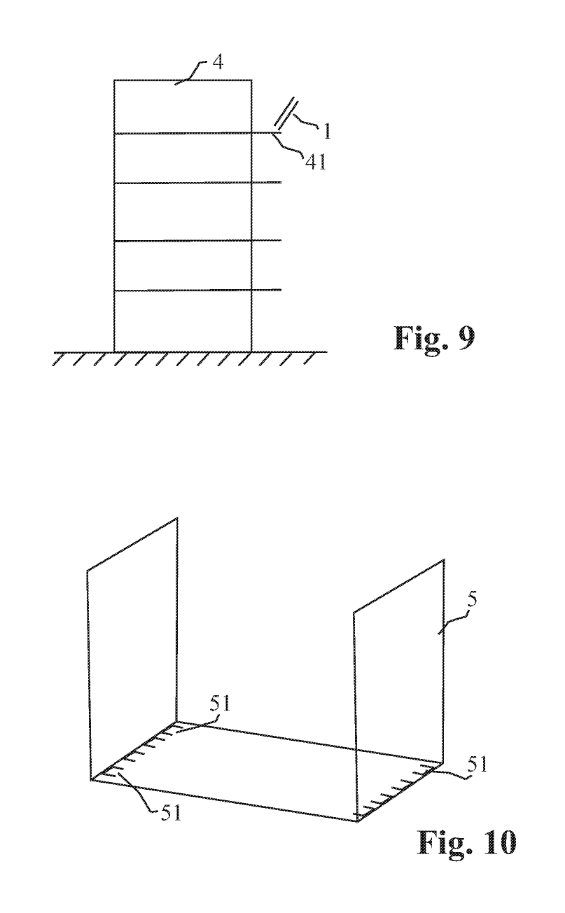

FIG. 9 illustrates a tri-dimensional display 1 mounted on the balcony 41 of a building 4. The tri-dimensional display 1 comprises two parallel boards mounted on a balcony 41 of a building 4.

The display 1 may have an angle of inclination to provide the best display when looking from a predefined location. With the angle of inclination as shown, the display may be used for best effect when viewed from the ground.

If it is desired to show the tri-dimensional image to observers in another building at about the same height as that of the display 1, a display having vertical boards may be used.

For viewing from a distance, a larger area board may be used, with larger holes made thereon.

FIG. 10 illustrates a tri-dimensional display test frame 5.

The frame 5 has several pairs of slots 51, for inserting a pair of boards with holes at a desired distance between the boards.

It is to be understood that preferred embodiments have been described to illustrate the present invention. These embodiments shall not limit the scope and spirit of the invention.

I claim as follows:

1. An apparatus for displaying tri-dimensional objects, comprising a pair of parallel boards, wherein each board has holes therein, wherein the holes are arranged in a pattern, and wherein the patterns of holes in the two boards are identical.

2. The apparatus according to claim 1, wherein each of the boards is planar.

3. The apparatus according to claim 1, wherein the pattern comprises holes arranged in a plurality of parallel rows.

4. The apparatus according to claim 1, wherein the holes are circular.

5. The apparatus according to claim 1, wherein the holes are rectangular.

6. The apparatus according to claim 1, wherein the holes are oval.

7. The apparatus according to claim 1, wherein the holes have an arbitrary shape each.

8. The apparatus according to claim 4, wherein the diameter of the holes is about 12 millimeters (mm).

9. The apparatus according to claim 1, wherein the holes are arranged in parallel rows.

10. The apparatus according to claim 1, wherein a distance between holes (measured between the holes centers) is about 18 millimeters.

11. An apparatus for displaying tri-dimensional objects, comprising six boards having holes therein, wherein opposite boards are parallel to each other and have an identical pattern of holes, and wherein adjacent boards are at a normal angle to each other.

12. The apparatus according to claim 11, having a width of about 19 centimeters (cm), a depth of about 19 cm and a height of about 25 cm.
